(19) United States
(12) Patent Application Publication
(10) Pub. No.: US 2008/0238104 A1
(43) Pub. Date: Oct. 2, 2008

(54) Pressurized water powered engine

(76) Inventor: Thomas W. Dale, Snow Hill, MD (US)

Correspondence Address: Thomas W. Dale, 6452 Snow Hill RD, Snow Hill, MD, 21863, US

(21) Appl. No.: 12/078,351

(22) Filed: Mar. 31, 2008

Related U.S. Application Data
(60) Provisional application No. 60/920,789, filed on Mar. 30, 2007.

(51) Int. Cl. F03B 13/06; F03B 7/00; H02K 7/20

(52) U.S. Cl. 290/54; 322/9

(57) ABSTRACT

A pressurized water powered machine that generates electrical power and is capable of driving a load which includes a waterwheel located above a water reservoir, a water pump that pressurizes water collected from the water reservoir and conveys it to a storage tank where it is stored under pressure for delivery to a water nozzle output which directs the pressurized water to the waterwheel, where the waterwheel powers a drive shaft that powers an electrical generator and is capable of being connected to a load.

This application claims the benefit of U.S. Provisional Patent Application No. 60/920,789, filed on Mar. 30, 2007.

### FIELD OF INVENTION

This invention relates to engines and particularly to an engine powered by water under high pressure.

### BACKGROUND TO THE INVENTION

In the past, many efforts have been made to develop an engine that is not fully dependent on fossil fuels or does not have the disadvantage of requiring frequent battery recharging that is currently associated with electrical battery powered automotive engines. An engine that can perform inexpensively on a readily available fuel source for an extended period of time with minimal re-charging of its battery power source is highly desirable.

Water engines are thermodynamic engines for converting the pressure and weight of water into work and have been widely recognized as efficient source of power. Examples include water turbines for generating electricity, and waterwheels for operating belts and drive shafts to turn machinery.

U.S. Pat. No. 4,345,160 discloses an electrical power generation system which includes a waterwheel contained in a housing enclosure, a water discharge nozzle which delivers water to the waterwheel. Water is delivered to the discharge nozzle by a pump which transports water discharged from the water wheel into a water collection tank back to the water discharge nozzle in a recirculation type mode. Using such an enclosed loop system, the turning of the waterwheel provides for the generation of electrical power which is, to a certain extent, regenerative to the operation of the water pump.

It has been found in the present invention that the power generated by a generally self-contained waterwheel engine can be increased by applying water under high pressure to the paddles of the water wheel. As a result, the power output of the water wheel is greatly enhanced while partial regeneration of power to the power supply of the engine is accomplished.

### SUMMARY OF THE INVENTION

According to the broadest aspect of the present invention, there is provided a method of turning the drive shaft of an engine with pressurized water wherein water is initially pressurized with power from an attached source of electrical power, such as a direct current (DC) battery or a series of DC batteries.

An object of the present invention is to provide an engine which uses water under high pressure as a means of creating power by turning a waterwheel which, in turn, is connected to a drive shaft that provides power to turn an electrical generator that produces electrical power as either direct current or alternating current or both, and, if desired, power a load by action of the drive shaft.

According to a another aspect of the invention, there is provided an engine driven by water under high pressure in which the water is initially pressurized with a water pressure pump powered by a power source such as a DC battery or series of DC batteries, wherein the pressurized water is directed to a water wheel and engages the paddles of the water wheel such that the wheel turns a drive shaft connected to the waterwheel. An electrical generator, otherwise known as an alternator, is engaged with the drive shaft by a power generation means, where the generator is turned or rotated at a high rate of speed by the drive shaft. Consequently, the generator is able to generate electrical current that is transferred through one or more terminal electrical outlets on the generator where the generated electricity is able to provide electricity externally to the machine, recharge the battery power source, and provide electrical power to the water pressure pump. To provide alternating current (AC), a voltage regulator means is placed by electrical connections between the generator and an electrical outlet terminal associated with the power generation means. To provide DC current, an AC/DC converter means is placed by electrical connection between the generator and a electrical outlet terminal associated with the power generation means. Furthermore, the drive shaft may be connected by a second connecting means to a load.

It is a further object of the present invention to provide an engine operated by the application of pressurized water in which the pressurized water is used to create power by turning a waterwheel or a turbine. The water is then recovered and recirculated in a closed circuit piping arrangement and re-pressurized to be reapplied for the purpose of turning the waterwheel. A DC battery or series of batteries is used to initially pressurize the water and provide power to drive a load at the start-up of the engine, and the battery is then partially re-charged by a generator which is turned as part of a power generation means connected to the drive shaft which, in turn, is attached to the waterwheel. This regeneration of power is intended to reduce the need for frequent recharging periods.

The present invention differs from prior art hydro-powered turbines and waterwheels used to generate electrical power and drive machinery through a series of drive shafts, gears, and belts in that the water is recycled and applied under pressure, and the apparatus is easily transportable, mobile, and easy to hook up to a load.

Further objects and advantages of the invention will become apparent from the following description, which is given by way of example.

### BRIEF DESCRIPTION OF THE DRAWINGS

The invention will now be described with reference to the accompanying drawings which show a pictorial view of the pressurized water engine incorporating the present invention.

FIG. 1 is a perspective view of the pressurized water powered engine constructed according to the present invention.

FIG. 2 is a side view of the drive shaft of the engine and the power generation means as well as the placement of the starter motor, the generator and the optional second electric motor.

FIG. 3 is a schematic diagram of the power supply circuit for operating the starter motor and the pressurized water pump which returns water from the water collection tray to the pressure tank reservoir, and the recharging circuit from the generator to the DC battery source.

### DETAILED DESCRIPTION OF THE INVENTION

The invention employs a waterwheel or turbine, herein referred to as a waterwheel that is completely located within a housing by means well know in the art. The waterwheel comprises a plurality of paddles or fins attached to a central hub which is directly connected to the drive shaft. The waterwheel is turned by the application of the force of high-pressure water directed at its fins or paddles. Only a small amount of water needs to be pressurized to drive the waterwheel. Water that is spent turning the waterwheel is collected in a water reservoir and recirculated via a piping system to a water pressure pump where it is pressurized and then stored under high pressure in a water pressure tank for delivery under pressure to the waterwheel. The pressure of the fluid stored for discharge onto the waterwheel ranges from 30 pounds per square inch (psi) to 3,000 psi, preferably 30 psi to 1000 psi.

In particular, the amount of water or fluid required for the operation of the engine is at least the minimal quantity required to turn the water wheel and be recirculated to the water pressure pump for continuous operation of the engine. The maximum amount of water can be no more than a volume of water in the water reservoir that allows for the free turning of the waterwheel.

It is understood that fluids which have flow characteristics, viscosity, and pressurization properties similar to water can be employed in the operation of the engine. These may include hydrodraulic fluids, vegetable oils, salt water, glycols, and the like. The use of salt water, glycols, and mixtures of glycols with water will inhibit freezing of fluids during cold weather. Although water is the preferred choice of fluid in the operation of the water pressure engine, and it is used throughout the description of the operation of the pressure water engine, it is understood that the above mentioned fluids may also be used.

A drive shaft is connected to the waterwheel at the hub of the waterwheel and is connected to power generating means for turning an electrical generator or alternator. The power generating means allows for the transfer of work from the drive shaft to the generator. An example of such a means is a geared wheel or a flywheel which is attached to a generator whereby the generator is electrically connected to a electrical outlet terminal for distributing electrical power. Furthermore, a toothed gear that is capable of rotating a generator and being rotated by a starter motor can be used as a first connection means. Consequently, the drive shaft is connected to a geared wheel or toothed gear which in turn is connected to a generator or alternator as a means for generating electrical power. The electrical generator is electrically connected to voltage regulator means if alternating current (AC) output from the electrical outlet terminal is desired and/or the generator is electrically connected to an AC/DC converter means if direct current output is from the electrical outlet terminal. Additionally, an electrical starter motor is placed adjacent to and allowed to be engaged to the geared wheel such that when the starter motor is activated, it is able to turn the geared wheel, which in turn is able to operate the generator. An optional second electrical motor powered by the DC battery source is able to turn the drive shaft by a connecting means such as a belt or a gear to assist in the turning of the drive shaft when fluctuations in low water pressure will have a negative effect on the continuous operation of the engine. The presence of the starter motor and an optional second electric motor allows for the continuous operation of the engine prior to the build-up of water pressure which is required to drive the waterwheel and, hence, the drive shaft. It also provides a continuous operation of the engine when loads and demands on the drive shaft are at peak levels. The driveshaft can then be connected to a drive connection means to provide power to a load, wherein the drive connection means may include a clutch means or a transmission.

A power means comprising a DC storage battery or a set of DC storage batteries consisting of at least one battery, preferably a plurality of batteries, will operate the water pressure pump and the starter motor to turn the drive shaft to allow for instantaneous and continued operation of the engine, prior to the ability of water under pressure to assist in the operation of the waterwheel, and hence the turning of the drive shaft. A battery pack of two or more batteries will allow for the discharge of one battery while a second battery is being recharged. Once the water pressure is of a sufficiently high level required to turn the water wheel at sufficient speed to sustain the load and turn the generator, the generator connected to the drive shaft will partially re-charge or regenerate power to the battery or plurality of batteries, and provide electrical power to the water pressure pump. When this is achieved, the starter motor can be disengaged from the connecting means to the drive shaft by means of a switch. To recharge the battery source and provide electrical power to the water pressure pump and motors requiring DC current, an AC/DC converter is connected by electrical wiring between the electrical output of the generator and the DC storage batteries.

The drive shaft can optionally be connected to a load via a drive mechanism means that includes a slip clutch that will enable the machine to remain in a neutral operational mode when operating.

The present invention requires water to be at a high enough pressure to turn the water wheel and its load at a revolution speed required to turn the generator to recharge the batteries in the battery pack, provide electrical power to the water pressure pump, and provide electrical power external to the engine.

When in operation and in a latent or non-operative mode, the evaporation of the water is kept minimal, because of the housing encasement around the waterwheel, and the water reservoir, and the piping of the water delivery system.

Further aspects and advantages of the invention will become apparent from the following example.

The invention will now be described with reference to the Figures.

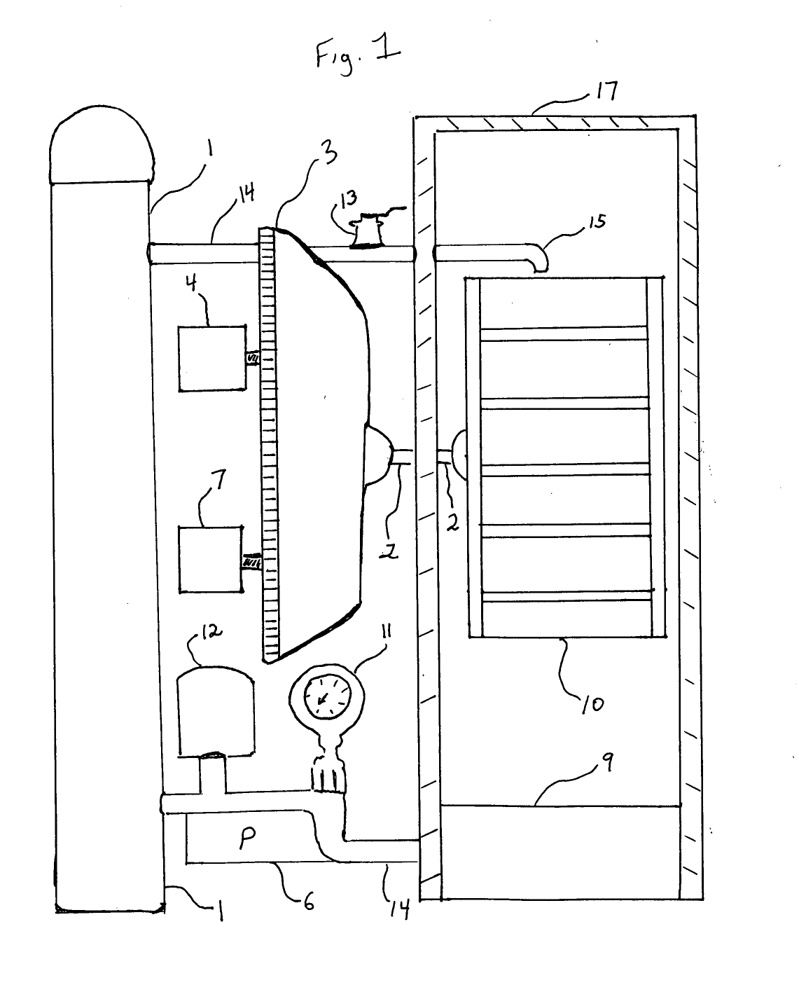

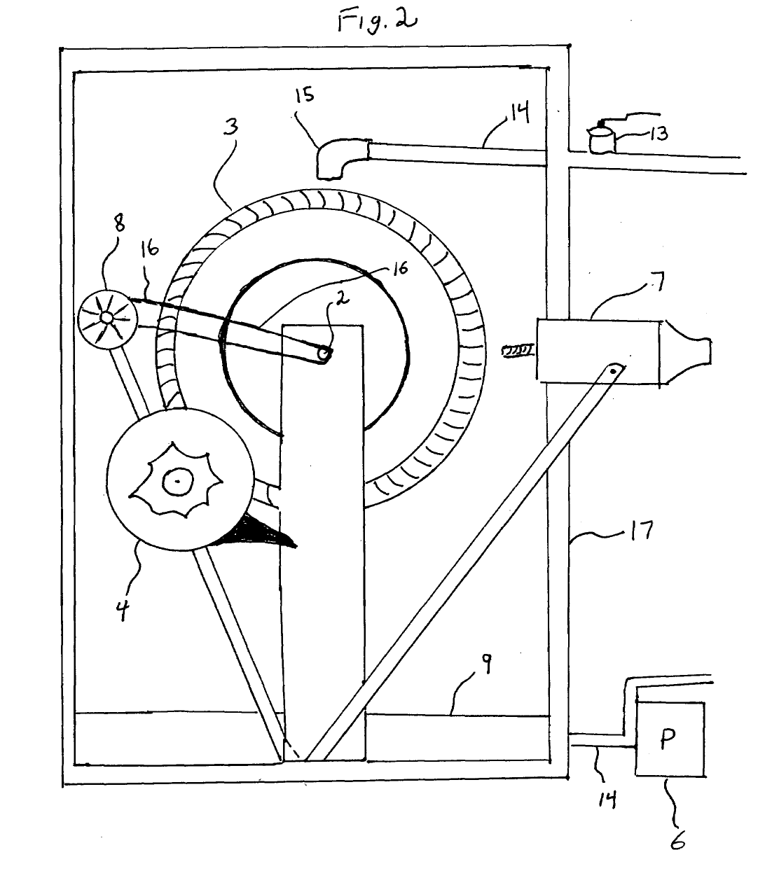

In FIGS. 1 and 2, the waterwheel 10, which is enclosed in a housing 17, is attached via a drive shaft 2 to a power generating means such as a geared wheel or flywheel 3. An alternator or electrical generator 4 is attached to the geared wheel in such a way that the geared wheel turns the generator to provide power to recharge a DC battery source 5 and provide power to the water-pressure pump 6. An electric starter motor 7 is also attached to the geared wheel and a second optional electrical motor 8 is attached to the drive shaft by a connecting means such as a belt 16 so that the motors are able to turn the geared wheel and, in turn, the drive shaft, but can be disengaged when not required to turn the flywheel. The electric starter motor 7 turns the geared wheel connected to the drive shaft when the water engine is initially turned on. The DC battery source 5 provides electrical power to the starter motor, the water pressure pump through switch S1, and, optionally, the second electrical motor through an additional switch. Electrical power provided by the battery and the generator being turned by the operation of the starter motor powers the water pressure pump 6 to transfer water from the water reservoir 9 to the water pressure tank 1 which is fitted with a pressure gauge 11 and pressure sensor 12. Once the level of water pressure required to operate the waterwheel is achieved, a one-way valve 13 is opened to allow the water under high pressure to be delivered through water transfer piping 14 and through a release nozzle 15 directed to the paddles of the waterwheel. The spent water is collected in the water reservoir 9 and recirculated through the piping system 14 to the water pressure pump 6 for re-pressurization. When the water wheel is turning at the required revolutions to drive the load and the generator connected to the flywheel, the starter motor is disengaged by means of a signal from the pressure sensor and the generator is able to recharge the battery pack via an AC/DC converter through switch S2, and provide power to the water pressure pump through switches S2 and S3. Continued operation of the water pump to deliver water at high pressure to the water wheel may require additional electricity from the electrical power source battery.

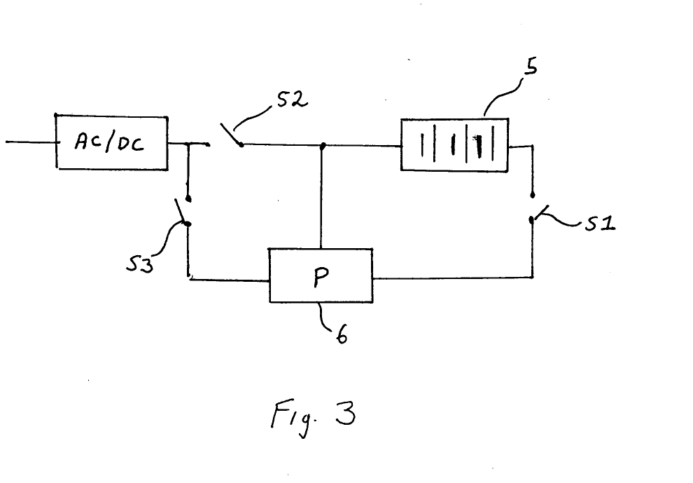

As described above, the water pressure pump is powered by a suitable DC power source such as an individual DC storage battery or an array of a plurality of DC storage batteries connected to the water pressure pump by means of a switch S1. In FIG. 3, it will be noted that the DC power source is connected to the output terminal of the generator 4 which includes a conventional AC to DC converter 16 to convert the output of the generator to direct current, where converted current may be used to partially recharge the DC power source. This provides a means by which the power source may be recharged when the load on the output terminal of generator is low. Thus, a switch S2 is provided for connecting the AC/DC converter output to the DC battery power source 5. Additionally, some of the electrical output of the generator can be selectively directed to the water pressure pump, as needed by switch S3.

Thus, by the invention, there is provided an engine operating efficiently and with optimum output to provide work to a load via pressurized water, that is generating electrical power to continue to pressurize the water required to operate the engine with minimal discharge of electrical power from the battery, thereby requiring less frequent re-charging times as required by current engines which are run solely by electricity from a battery source.

When in the forgoing description particular mechanical items are described by way of example, it is envisaged that their mechanical equivalents may be substituted as if they were individually set forth herein.

A particular example of the invention has been described and it is envisaged that improvements and modification can take place without departing from the scope of the invention.

What is claimed is:

1. A power generating apparatus comprising:
a. a housing enclosure;
b. a waterwheel with paddles positioned in the housing enclosure in an upright position having a plurality of paddles emanating from the center hub of the water wheel used for turning the waterwheel when fluid under pressure is discharged against the blades;
c. a means of supporting the waterwheel in the housing enclosure;
d. a water reservoir located below the waterwheel such that the fluid discharge from the waterwheel is collected;
e. a drive shaft connected to the waterwheel;
f. a power generation means attached to the drive shaft;
g. an electrical starter motor positioned such that it can be contacted with the power generation means and cause to turn the power generation means;
h. a water supply means comprising a water pressure pump, a pressurized storage tank, and water piping to transfer fluid to be pressurized and operate the waterwheel;
i. a release nozzle to direct fluid under pressure against the paddles of the waterwheel paddles causing the waterwheel to turn;
j. a power supply means; and
k. a fluid which is used in the water supply means.

2. The apparatus of claim 1 which comprises an optional second electrical motor and a connecting means of turning the drive shaft.

3. The apparatus of claim 2 wherein the connecting means is a gear or a belt or a combination thereof.

4. The apparatus of claim 1 wherein the power generation means comprises an electrical generator which is electrically connected to an electrical output terminal wherein the generator is turned by a geared wheel attached to the drive shaft

5. The apparatus of claim 4 wherein the power supply means includes a DC battery or a plurality thereof electrically connected to the starter motor, the water pressure pump, and a means for recharging the DC battery.

6. The apparatus of claim 5 wherein the means for recharging the battery includes the DC battery connected to an output terminal of the generator, and AC/DC converter means electrically connected between the generator and the output terminal of the generator, and a switch means for connecting the DC storage battery in circuit with the output terminal of the generator.

7. The apparatus of claim 6 wherein the fluid in the pressurized storage tank has a pressure of 30 psi to 3,000 psi when the apparatus is functioning.

8. The apparatus of claim 7 wherein in the fluid is selected from hydraulic fluid, vegetable oils, salt water, glycols, and water.

9. The apparatus of claim 8 wherein the fluid is water.

10. The apparatus of claim 9 wherein the water in the pressurized storage tank has a pressure of 30 psi to 1,000 psi when the apparatus is functioning.

11. A power generating apparatus comprising:
a. a housing enclosure;
b. a waterwheel with paddles positioned in the housing enclosure in an upright position having a plurality of paddles emanating from the center hub of the water wheel used for turning the waterwheel when fluid under pressure is discharged against the blades;
c. a means of supporting the waterwheel in the housing enclosure;
d. a water reservoir located below the waterwheel such that the fluid discharge from the waterwheel is collected;
e. a drive shaft connected to the waterwheel;
f. a power generation means attached to the drive shaft;
g. an electrical starter motor positioned such that it can be contacted with the power generation means and cause to turn the power generation means;
h. a water supply means comprising a water pressure pump, a pressurized storage tank, and water piping to transfer fluid to be pressurized and operate the waterwheel;
i. a release nozzle to direct fluid under pressure against the paddles of the waterwheel paddles causing the waterwheel to turn;
j. a power supply means;
k. a fluid which is used in the water supply means; and
a second connecting means to the drive shaft.

12. The apparatus of claim 11 wherein the second connecting means is a clutch or a transmission.
